(19) United States
(12) Patent Application Publication
(10) Pub. No.: US 2007/0265822 A1
(43) Pub. Date: Nov. 15, 2007

(54) Data processing system and method

(75) Inventors: Bruce James Mathewson, Papworth Everard (GB); Sheldon James Woodhouse, Claythorpe (GB); Christopher Baxter, Baldock (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/431,925

(22) Filed: May 11, 2006

(51) Int. Cl. G06F 9/45

(52) U.S. Cl. 703/22

(57) ABSTRACT

A method of generating simulated data signals, data processing system and software model are disclosed. The method comprises the steps of: a) providing input data signals to a component of a data processing apparatus; b) capturing a representation of the input data signals; c) providing a software model operable to simulate the behaviour of the component of the data processing apparatus; and d) executing the software model using the captured representation of the input data signals to generate simulated data signals representing the behaviour of the component of the data processing apparatus in response to the input data signals. Using a software model to emulate the behaviour of the component in response to the input data signals obviates the need to manufacture a test chip for debugging purposes. Also, any timing issues which arise when using a test chip can be obviated by using a software model. Furthermore, the amount of information generated by a software model can easily exceed the amount of information accessible from a test chip which greatly increases debugging effectiveness.

### FIELD OF THE INVENTION

The present invention relates to a data processing system and method.

### BACKGROUND OF THE INVENTION

When developing a data processing system, it is desirable to be able to debug the operation of the data processing system and understand its behaviour under a wide range of operating conditions.

Various known debug techniques exist. For example, it is known to operate a data processing system under representative conditions and then monitor data signals generated by components of the data processing system. When components of the data processing system are provided as separate units, the buses and paths within those components may be externally accessible. Accordingly, performing such debugging under such conditions is a relatively straightforward task since logic analysers may be coupled directly to those buses and paths in order to monitor and record the data signals.

However, as components become more complex, the accessibility of data signals within the components reduces, since such access is typically limited by the number of external pins provided for that component. Also, as the data processing systems become more complex and components become more deeply embedded within the data processing system, such as in system-on-a-chip arrangements, the accessibility of the components themselves may reduce, again due to the limitation of the number of external pins provided for the data processing apparatus.

However, as data processing systems increase in complexity, it will be appreciated that the need to be able to comprehensively debug the data processing system also increases.

In one known approach, as described in U.S. Pat. No. 5,809,037, a test chip is provided which has the same hardware configuration as a component within the data processing system. The test chip is arranged within a test environment which enables access to an increased amount of information than is available by accessing the data processing system. Data signals provided to the component within the data processing system are also provided to the test chip. Given that these two components are essentially identical, it can be assumed that the test chip will respond to the data signals it receives in the same way as the corresponding component in the data processing system.

Whilst this approach can provide increased visibility during debugging, it has a number of disadvantages. Accordingly, it is desired to provide an improved technique for characterising the operation of the data processing system.

### SUMMARY OF THE INVENTION

According to a first aspect of the present invention there is provided a method of generating simulated data signals, the method comprising the steps of: a) providing input data signals to a component of a data processing apparatus; b) capturing a representation of the input data signals; c) providing a software model operable to simulate the behaviour of the component of the data processing apparatus; and d) executing the software model using the captured representation of the input data signals to generate simulated data signals representing the behaviour of the component of the data processing apparatus in response to the input data signals.

The present invention recognises that there are numerous disadvantages with the test chip approach mentioned above.

Firstly, that approach is reliant upon there being available a test chip which has the same hardware configuration as the component within the data processing system. Whilst it has often been the case that such a test chip has historically generally been manufactured, doing so is becoming less common due to the increasing costs of performing bespoke chip manufacture. Accordingly, it may be the case that such a test chip is never manufactured. Hence, the above-mentioned approach cannot be used for debugging.

Secondly, the test chip technique is relatively complicated since it is necessary to operate the data processing system and the test chip together in real-time. Because these systems are operating in real-time, it may be difficult to provide, over the bus connecting the data processing system with the test chip, all of the data signals provided to the component in the data processing system. Also, as the internal bus width of data processing systems increases, the quantity of data signals which is required to be provided to the test chip also increases. Furthermore, propagating the data signals from the data processing system to the test chip runs the risk of altering the characteristics of the data signals received by the test chip such that it operates slightly differently to component within the data processing system.

Thirdly, whilst the test chip can provide for a degree of increased visibility, this again is limited by the number of external pins which are accessible to provide data signals for use during debugging.

Accordingly, a data processing apparatus having a component whose behaviour is to be characterised is provided. The component is provided with input data signals. A software model which models the behaviour of the component of the data processing apparatus is also provided. A representation of the input data signals provided to the component of the data processing apparatus are captured. The software model is provided with the captured input data signals and then generates simulated data signals indicative of the behaviour of the component in response to the input signals.

In this way, there is no need to provide a test chip for the component being characterised. Instead, a software model is provided and that software model emulates the behaviour of the component in response to the input data signals. Accordingly, the need to manufacture a test chip for debugging purposes is obviated. Although this approach requires the provision of a software model, such software models are now ubiquitous during the development of data processing apparatus. Also, even if such software models are not available, the relative cost of providing such a software model is many times less than that of manufacturing a hardware test chip.

Also, whilst the operation of the component in the data processing apparatus and the data capture can occur in real-time, there is no such limitation on the operation of the software model. Instead, the software model can utilise the captured input data in any convenient time-frame. Hence, the particular timing issues which arise when using a test chip can be obviated by using a software model.

Furthermore, by using a software model, the amount of information generated by such a model can easily exceed the amount of information accessible from a test chip which greatly increases debugging effectiveness.

In one embodiment, the data processing apparatus comprises a system-on-a-chip.

Accordingly, this technique is particularly applicable to arrangements where the components of the data processing apparatus are provided within a system-on-a-chip. It will be appreciated that components within a system-on-a-chip are even more deeply embedded. As a consequence, the accessibility of those components and the associated visibility of the operation of those components becomes more difficult. However, accessibility is provided through the software model.

In one embodiment, step d) comprises executing the software model using the captured representation of the input data signals to generate simulated internal data signals representing signals generated within the component of the data processing apparatus in response to the input data signals.

Hence, the software model can provide visibility of internal data signals within the component which are generated in response to the input data signals. It will be appreciated that such internal signals may be particularly difficult to access in a deeply embedded systems.

In one embodiment, step d) comprises executing the software model using the captured representation of the input data signals to generate simulated output data signals representing output signals of the component of the data processing apparatus in response to the input data signals.

Accordingly, the software model may provide output data signals which would be generated by the component in response to the input data signals. It will be appreciated that deriving the output data signals from the input data signals removes the need to capture these output data signals from the component within the data processing apparatus. This in turn reduces the amount of data which needs to be captured from the data processing apparatus.

In one embodiment, the input signals represent compressed data values and the simulated output data signals represent uncompressed data values.

Accordingly, it will be appreciated that where the component generates uncompressed data from compressed input data, the amount of data generated by that component will greatly exceed the amount of data which was input to the component. Hence, capturing the compressed data and using the software model to generate the uncompressed data significantly reduces the amount of data which needs to be captured from the data processing apparatus.

In one embodiment, the data processing apparatus comprises at least one additional component operable to receive output data signals from the component, the step c) comprises providing a software model operable to simulate the behaviour of the component and the additional component of the data processing apparatus and the step d) comprises executing the software model using the captured representation of the input data signals to generate simulated output data signals representing output signals of the component of the data processing apparatus in response to the input data signals and using the simulated output data signals to generate additional data signals representing the behaviour of the additional component of the data processing apparatus in response to the input data signals.

Hence, where a further component is provided which receives output data from the first component, there is no need to capture the data provided to the additional component in order to understand its behaviour. Instead, the input data to the first component can simply be captured and this data provided to the software model. The software model will generate the output data of the first component in response to the input data and provide this to a model of the additional component in order to generate the additional data signals representing the behaviour of the additional component. It will be appreciated that this significantly reduces the amount of data which needs to be captured from the data processing apparatus.

In one embodiment, step d) comprises executing the software model using the captured representation of the input data signals to generate the simulated output data signals representing the output signals of the component of the data processing apparatus in response to the input data signals and using the simulated output data signals to generate additional internal data signals representing signals generated within the additional component of the data processing apparatus in response to the input data signals.

Accordingly, the internal data generated by the additional component can be derived using the software model from the input data which has been captured.

In one embodiment, step d) comprises executing the software model using the captured representation of the input data signals to generate the simulated output data signals representing the output signals of the component of the data processing apparatus in response to the input data signals and using the simulated output data signals to generate additional output data signals representing signals output by the additional component of the data processing apparatus in response to the input data signals.

Similarly, the output data of the additional component can be derived simply from the input data which has been captured.

In one embodiment, step b) further comprises the step of capturing a representation of data signals generated by the component of the data processing apparatus in response to the input data signals.

Hence, the actual data signals generated by the component may also be captured.

In one embodiment, step b) further comprises the step of capturing a representation of internal data signals generated within the component of the data processing apparatus in response to the input data signals.

Hence, internal signals generated by the component may also be captured.

In one embodiment, step b) further comprises the step of capturing a representation of output data signals output by the component of the data processing apparatus in response to the input data signals.

Accordingly, data signals output by the component may also be captured.

In one embodiment, step d) further comprises the step of providing the captured representation of data signals generated by the component of the data processing apparatus to the software model.

In one embodiment, step d) further comprises the step of comparing the simulated data signals generated by the software model with the captured representation of data signals generated by the additional component of the data processing apparatus.

Accordingly, the data signals captured from the component may also be provided to the software model. Providing this actual captured data to the software model enables this information to be compared with any other information generated by the model to help characterise the operation of the data processing apparatus or verify the integrity of the data capture and modelling components.

In one embodiment, the data processing apparatus comprises at least one additional component and step b) further comprises the step of capturing a representation of data signals generated by the additional component of the data processing apparatus.

Hence, signals generated by the additional components may also be captured.

In one embodiment, step b) further comprises the step of capturing a representation of internal data signals generated within the additional component of the data processing apparatus.

Accordingly, internal signals within the additional component may be captured.

In one embodiment, step b) further comprises the step of capturing a representation of output data signals output by the additional component of the data processing apparatus.

Similarly, output data signals generated by the additional component may be captured.

In one embodiment, step d) further comprises the step of providing the captured representation of data signals generated by the additional component of the data processing apparatus to the software model.

Likewise, the captured data signals of the additional component may also be provided to the software to assist in understanding the behaviour of the data processing apparatus or verify the integrity of the data capture and modelling components.

In one embodiment, step b) comprises capturing a representation of the input data signals in a stored data file.

Accordingly, the captured data signals may be stored in a data file. It will be appreciated that the data file may take any particular form which is convenient to either the capturing process or a form which is convenient to the software model.

In one embodiment, step d) comprises providing the representation of the input data signals stored in the data file to a file reader to generate transactions to stimulate executing the software model to generate the simulated data signals representing the behaviour of the component of the data processing apparatus in response to the input data signals.

Accordingly, the data file may be read by a file reader in order to generate transactions representative of the captured data in order to stimulate the software model.

In one embodiment, step b) comprises capturing a representation of the input data signals by sampling from a bus.

Hence, the captured data signals may be sampled directly from a bus within the data processing apparatus.

In one embodiment, step b) comprises capturing a representation of the input data signals by tracing the input data signals using a trace module.

Accordingly, a trace unit may be provided to generate trace data from the input signals provided to the component. The trace data may then be decoded by a trace module in order to reconstruct the input signals. It will be appreciated that by using trace techniques, bandwidth limitations associated with exported data from the system on the chip may be reduced.

In one embodiment, step d) comprises single-stepping the software model using the captured representation of the input data signals to generate simulated data signals representing the behaviour of the component of the data processing apparatus in response to the input data signals.

Accordingly, the model does not need to be operated in real-time and can instead be single-stepped. Such single-stepping can either be on the basis of the advancement of a signal clock cycle or can be on the basis of the provision of a single input data value.

In one embodiment, the method further comprises the step of: e) analysing the simulated data signals using model analysis tools.

Accordingly, the simulated data signals may be analysed using standard model analysis techniques. It will be appreciated that such tools provide significantly greater visibility and analysis of information than would be available when using a test chip.

In one embodiment, step e) comprises determining waveform representations of the simulated data signals.

In one embodiment, step e) comprises determining one of register and memory contents derivable from the simulated data signals.

In one embodiment, step e) comprises determining statistical information derivable from the simulated data signals.

In one embodiment, step a) comprises providing input data signals to the component of the data processing apparatus in response to a sequence of instructions being executed by the data processing apparatus.

Accordingly, the input signals may occur in response to instructions being executed by the data processing apparatus.

According to a second aspect of the present invention, there is provided a data processing system comprising: logic operable to capture a representation of input data signals provided to a component of a data processing apparatus; a software model operable to simulate the behaviour of the component of the data processing apparatus, the software model being further operable using the captured representation of the input data signals to generate simulated data signals representing the behaviour of the component of the data processing apparatus in response to the input data signals.

According to a third aspect of the present invention, there is provided a software model operable when executed on a computer to simulate the behaviour of a component of a data processing apparatus, the software model comprising: a model interface operable to receive a captured representation of input data signals received by the component of the data processing apparatus; and a simulation model operable to generate, from the captured representation of input data, simulated data signals representing the behaviour of the component of the data processing apparatus in response to the input data signals.

In embodiments, the software model comprises features provided by the second aspect of the present invention.

The above, and other objects, and features and advantages of this invention will be apparent from the following detailed description of illustrative embodiments which is to be read in conjunction with the accompanying drawings.

### BRIEF DESCRIPTION OF THE DRAWINGS

Embodiments of the present invention will now be described with reference to the accompanying drawings in which:

FIG. 1 illustrates a data processing system according to an embodiment of the present invention; and

FIG. 2 is a flow chart illustrating the operation of the data processing system shown in FIG. 1.

### DESCRIPTION OF THE EMBODIMENTS

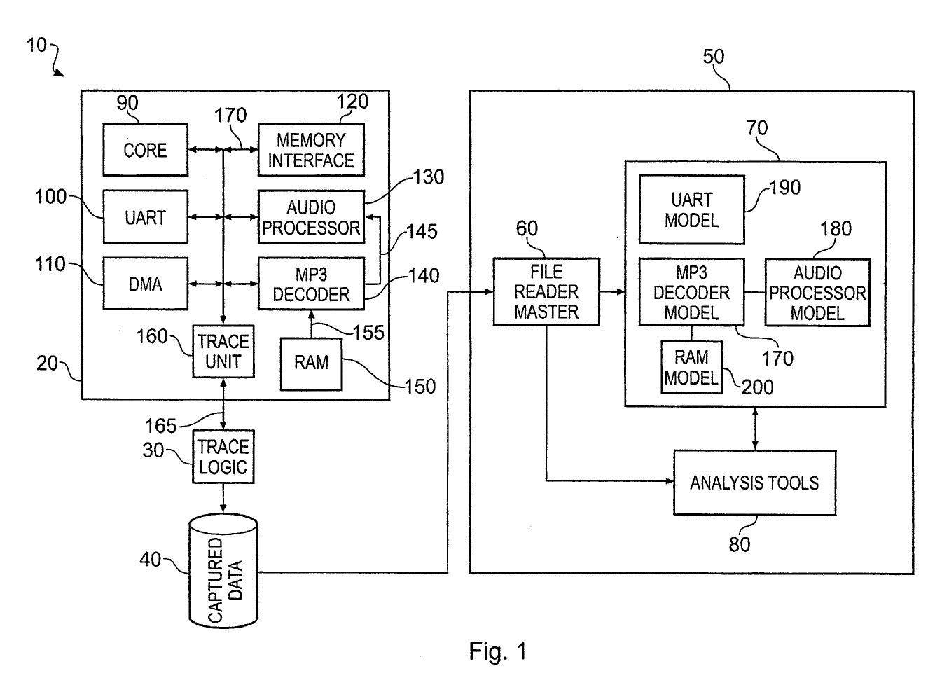

FIG. 1 illustrates a data processing system, generally 10, according to an embodiment of the present invention.

The data processing system 10 comprises a data processing apparatus 20 coupled with trace logic 30 arranged to store captured data as a data file 40. Also provided is simulation software 50 comprising a file reader master 60 for reading the captured data from the data file 40, a system model 70 comprising one or more models of components of the data processing apparatus 20 and analysis tools 80.

The data processing apparatus 20 is provided as a system-on-a-chip (SOC). In this example, the data processing apparatus 20 comprises a processor core 90, a universal asynchronous receiver transmitter (UART) 100, a direct memory access (DMA) controller 110, a memory interface 120, an audio processor 130, an MP3 decoder 140, a random access memory 150 and a trace unit 160, all coupled to an AXI interface 170. A RAM 150 is coupled over a path 155 with the MP3 decoder 140. The RAM 150 stores data used to configure the operation of the MP3 decoder 140. A dedicated bus 145 is provided coupling the MP3 decoder 140 with the audio processor 130. The bus 145 provides decoded audio data output by the MP3 decoder 140 directly to the audio processor 130 for subsequent processing. The trace unit 160 is configurable to perform trace in accordance with pre-programmed conditions, as is well known in the art. It will be appreciated that any other data processing apparatus 20 arrangement could be provided.

Given that the data processing apparatus 20 is provided as a system-on-a-chip, the accessibility to signals, data and state within the data processing apparatus 20 is low. Hence, there is limited visibility of the internal operation of the data processing apparatus 20 since the number of external pins of the data processing apparatus 20 which can be used to provide data relating to the internal operation is limited.

However, the trace unit 160 is configured to capture data signals from within the data processing apparatus 20 and to provide these over a trace bus 165 to external trace logic 30. The trace unit 160 is ideally configured to compress or encode the trace data prior to transmitting this over the bus 165 to the external trace logic 30 in accordance with techniques well known in the art. Compressing or encoding the trace data increases the effective amount of data that can be transmitted over the limited bandwidth provided by the trace bus 165. The external trace logic 30 then decompress and/or decode this information prior to storing the captured data as a data file 40. It will be appreciated that whilst using trace techniques provides many advantages, any other technique for capturing the data could also be used.

Consider the situation where the operation of the MP3 decoder 140 needs to be more fully understood. The trace unit 160 is configured to capture any data signals provided as an input to the MP3 decoder 140. This is done by configuring the trace unit 160 to monitoring and trace the data signals provided over the AXI bus 170 which are addressed to the MP3 decoder 140. These input data signals are then captured by the trace unit 160 and transmitted over the trace bus 165 to the trace logic 30. The trace logic 30 then decodes the captured input data signals and stores these as a data file 40. Accordingly, the data processing apparatus 20 can be operated in real-time whilst the input data signals are captured, this helps to ensure that the data processing apparatus 20 operates in as representative manner as possible. Once the input data signals have been captured and written to the data file 40, the data processing apparatus 20 can cease operation. Once the data has been captured and stored in the data file 40, this can then be provided as required to the simulation software 50.

As mentioned previously, because the MP3 decoder 140 is deeply embedded within the data processing apparatus 20, it is difficult to obtain detailed information relating to the internal status of the MP3 decoder 140 or to determine the output signals provided over the bus 145 to the audio processor 130. Whilst it is at least theoretically possible to also provide at least some of this information using the trace unit 160, it will be appreciated that this will significantly increase the amount of information which needs to be transmitted over the trace bus 165. Furthermore, if it is desired to understand the operation of the audio processor 130 in response to the signals provided by the MP3 decoder 140 the amount of information which needs to be transmitted over the trace bus 165 begins to increase dramatically. However, as will be explained in more detail below, by capturing the input data to the MP3 decoder 140 and providing this to a MP3 decoder model 170, the operation of the MP3 decoder can be fully characterised. Furthermore, if an audio processor model 180 is also provided and the output from the MP3 decoder model 170 is provided to the audio processor model 180 then the operation of the audio processor 130 can also be fully characterised.

Accordingly, once the required data in the data file 40, this is provided to the simulation model 50. A file reader master 60 parses the data file 40 and generates transactions, these transactions drive the software model 70. The software model 70 comprises a one or more individual models, each of which model a corresponding component of the data processing apparatus 20. In this example, the software model 70 comprises an MP3 decoder model 170, an audio processor model 180, a UART model 190 and a RAM model 200.

The individual models simulate the operation of the corresponding components within the data processing apparatus 20. In this example, the software model 70 is an electronic system level (ESL) model written in C, C++ or system C. However, the software model may contain further or alternative levels of abstractions such as run time logic (RTL) models. Such models are typically created during the design of the components of the data processing apparatus 20.

The software model 70 responds to the transactions generated by the file reader master 60 and models the operation of the respective components. For example, transactions representing the input data signals captured and stored as the data file 40 are provided to the file reader master 60 which then feeds the MP3 decoder model 170. The MP3 decoder model 170 will then model the operation of the MP3 decoder 140 in response to those input signals, based on the settings within the RAM model 200. In this way, the internal configuration and signals within the MP3 decoder 140 can be derived from the MP3 decoder model 170. Similarly, any output signals provided over the bus 145 to the audio processor 130 can be derived and these signals can be provided as inputs to the audio processor model 180. Accordingly, the internal configuration and signals within the audio processor 130 can be derived from the audio processor model 180. Equally, any output signals provided by the audio processor 130 can also be derived from the audio processor model 180, based simply on the data signals input to the MP3 decoder 140.

It will be appreciated that this approach enables a large amount of information regarding the behaviour and operation of the data processing apparatus 20 to be derived from a relatively small amount of actual captured information.

For example, the data provided to the MP3 decoder 140 which is captured will typically be compressed audio data. The data output by the MP3 decoder over the bus 145 will be uncompressed audio data of a significantly greater quantity than that input to the MP3 decoder 140. Similarly, the uncompressed audio data provided over the bus 145 to the audio processor 130 will typically be less than the data output by the audio processor 130. For example, should the audio processor 130 perform 5.1 channel decoding, the five audio streams output from the audio processor 130 will be a significantly greater quantity of data than the uncompressed audio stream provided over the bus 145. However, this approach obviates the need to capture any of this subsequent data and instead all that is captured is the input data to the MP3 decoder 140. From that input data all the resultant data can be derived using the software models 170.

The data generated by the software model 70 may then be analysed using conventional analysis tools which will typically provide a much greater range of information than would be available using the test chip approach mentioned above. Also, the timing of the model can be controlled, for example, the operation of the model can be halted, reversed or advanced, all of which without affecting the operation of the model. Furthermore, information such as the particular status of a bus or a path associated with a component can be fully characterised, as can be the contents of any registers or the values of any memory transactions. Equally, the characteristics of any wave forms generated by the components can be determined as can other statistical data. Such information may be very difficult or even impossible to obtain, even when using a test chip.

In some circumstances, it may be necessary to capture the inputs of more than one components within the data processing apparatus 20. Accordingly, the trace unit 160 can be configured to capture these multiple inputs for storage in the data file 40 for subsequent use by the simulation software 50. Also, the trace unit 160 can be configured to capture data from within the components of the data processing apparatus and/or to capture data output by those components for storage in the data file 40.

This captured data can then be provided to the model to assist in any analysis. For example, captured output data can be used to drive the inputs to individual models within the software model 70. Alternatively, any captured output data can be compared with output data generated by the software model 70 for validation or verification purposes. It will be appreciated that through this approach, the visibility of the operation of components within the data processing apparatus 20 is significantly improved.

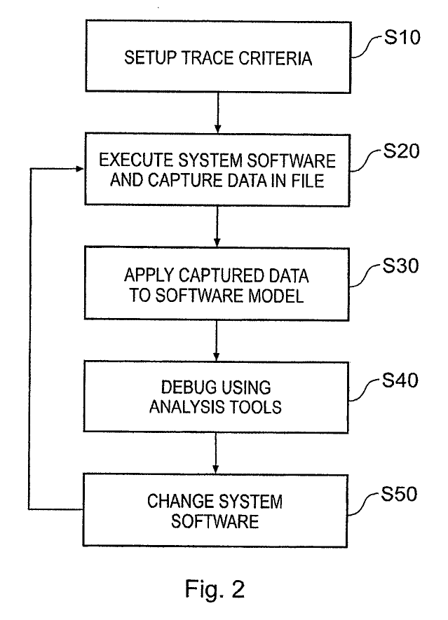

FIG. 2 is a flow diagram illustrating the operation of the data processing system 10 shown in FIG. 1.

At step S10, the trace criteria are determined and the trace unit 160 is configured. For example, the trace unit may be configured to trace data provided to the MP3 decoder 140 and the UART 100.

At step S20, the operation of the data processing apparatus 20 is initiated. In this example, the data processing apparatus 20 executes pre-programmed system software comprising a sequence of instructions. However, it will be appreciated that the data processing apparatus need not necessarily execute system software but may just respond to stimuli such as, for example, would occur if the data processing apparatus 20 was a state machine. During the operation of the data processing apparatus 20, the trace unit 60 transmits trace data over the trace bus 165 to the trace logic 30 for storage as the data file 40.

At step S30, the file reader master 60 reads the data file 40 and generates transaction to drive the software model 70.

At step S40, the operation of the software model 70 is controlled using the analysis tools 80. The operation of the data processing apparatus 20 is then debugged using those tools.

Thereafter, at step S50, in the event that there is undesirable or non-optimal operation of the data processing apparatus 20, the system software being executed by the data processing apparatus 20 may be changed. In the event that the system software is changed then processing returns to step S20 where the changed software is executed on the data processing apparatus 20 and its revised operation traced by the trace unit 160 once more. It will be appreciated that changes could instead be made to components of the software model 70 in order to understand how the data processing apparatus 20 may operate with a new hardware design.

Hence, it can be seen that by providing a software model the behaviour of the component in response to the input data signals can be simulated. Accordingly, the need to manufacture a test chip for debugging purposes is obviated. Whilst the operation of the component in the data processing apparatus and the data capture can occur in real-time, the software model can utilise the captured input data in any convenient time-frame. Hence, the particular timing and signal propagation issues which arise when using a test chip can be obviated by using a software model. Furthermore, debugging effectiveness can be greatly increased since the amount of information generated by such a model can greatly exceed the amount of information required to be captured to drive the model and this can easily exceed the amount of information accessible from a test-chip.

Although illustrative embodiments of the invention have been described in detail herein with reference to the accompanying drawings, it is understood that the invention is not limited to these precise embodiments and that various changes and modifications can be effected therein by one skilled in the art without departing from the scope and spirit of the invention as defined by the appended claims.

We claim:

1. A method of generating simulated data signals, said method comprising the steps of:
a) providing input data signals to a component of a data processing apparatus;
b) capturing a representation of said input data signals;
c) providing a software model operable to simulate the behaviour of said component of said data processing apparatus; and
d) executing said software model using said captured representation of said input data signals to generate simulated data signals representing the behaviour of said component of said data processing apparatus in response to said input data signals.

2. The method of claim 1, wherein said data processing apparatus comprises a system-on-a-chip.

3. The method of claim 2, wherein said step d) comprises executing said software model using said captured representation of said input data signals to generate simulated internal data signals representing signals generated within said component of said data processing apparatus in response to said input data signals.

4. The method of claim 2, wherein said step d) comprises executing said software model using said captured representation of said input data signals to generate simulated output data signals representing output signals of said component of said data processing apparatus in response to said input data signals.

5. The method of claim 4, wherein said input signals represent compressed data values and said simulated output data signals represent uncompressed data values.

6. The method of claim 2, wherein said data processing apparatus comprises at least one additional component operable to receive output data signals from said component, said step c) comprises providing a software model operable to simulate the behaviour of said component and said additional component of said data processing apparatus and said step d) comprises executing said software model using said captured representation of said input data signals to generate simulated output data signals representing output signals of said component of said data processing apparatus in response to said input data signals and using said simulated output data signals to generate additional data signals representing the behaviour of said additional component of said data processing apparatus in response to said input data signals.

7. The method of claim 6, wherein said step d) comprises executing said software model using said captured representation of said input data signals to generate said simulated output data signals representing said output signals of said component of said data processing apparatus in response to said input data signals and using said simulated output data signals to generate additional internal data signals representing signals generated within said additional component of said data processing apparatus in response to said input data signals.

8. The method of claim 6, wherein said step d) comprises executing said software model using said captured representation of said input data signals to generate said simulated output data signals representing said output signals of said component of said data processing apparatus in response to said input data signals and using said simulated output data signals to generate additional output data signals representing signals output by said additional component of said data processing apparatus in response to said input data signals.

9. The method of claim 2, wherein said step b) further comprises the step of capturing a representation of data signals generated by said component of said data processing apparatus in response to said input data signals.

10. The method of claim 9, wherein said step b) further comprises the step of capturing a representation of internal data-signals generated within said component of said data processing apparatus in response to said input data signals.

11. The method of claim 9, wherein said step b) further comprises the step of capturing a representation of output data signals output by said component of said data processing apparatus in response to said input data signals.

12. The method of claim 9, wherein said step d) further comprises the step of providing said captured representation of data signals generated by said component of said data processing apparatus to said software model.

13. The method of claim 2, wherein said data processing apparatus comprises at least one additional component and said step b) further comprises the step of capturing a representation of data signals generated by said additional component of said data processing apparatus.

14. The method of claim 13, wherein said step b) further comprises the step of capturing a representation of internal data signals generated within said additional component of said data processing apparatus.

15. The method of claim 13, wherein said step b) further comprises the step of capturing a representation of output data signals output by said additional component of said data processing apparatus.

16. The method of claim 13, wherein said step d) further comprises the step of providing said captured representation of data signals generated by said additional component of said data processing apparatus to said software model.

17. The method of claim 16, wherein said step d) further comprises the step of comparing said simulated data signals generated by said software model with said captured representation of data signals generated by said additional component of said data processing apparatus.

18. The method of claim 2, wherein said step b) comprises capturing a representation of said input data signals in a stored data file.

19. The method of claim 18, wherein said step d) comprises providing said representation of said input data signals stored in said data file to a file reader to generate transactions to stimulate executing said software model to generate said simulated data signals representing the behaviour of said component of said data processing apparatus in response to said input data signals.

20. The method of claim 2, wherein said step b) comprises capturing a representation of said input data signals by sampling from a bus.

21. The method of claim 2, wherein said step b) comprises capturing a representation of said input data signals by tracing said input data signals using a trace module.

22. The method of claim 2, wherein said step d) comprises single-stepping said software model using said captured representation of said input data signals to generate simulated data signals representing the behaviour of said component of said data processing apparatus in response to said input data signals.

23. The method of claim 2, further comprising the step of:
e) analysing said simulated data signals using model analysis tools.

24. The method of claim 23, wherein said step e) comprises determining waveform representations of said simulated data signals.

25. The method of claim 23, wherein said step e) comprises determining at least one of register and memory contents derivable from said simulated data signals.

26. The method of claim 23, wherein said step e) comprises determining statistical information derivable from said simulated data signals.

27. The method of claim 23, wherein said step a) comprises providing input data signals to said component of said data processing apparatus in response to a sequence of instructions being executed by said data processing apparatus.

28. A data processing system comprising:
logic operable to capture a representation of input data signals provided to a component of a data processing apparatus;
a software model operable to simulate the behaviour of said component of said data processing apparatus, said software model being further operable using said captured representation of said input data signals to generate simulated data signals representing the behaviour of said component of said data processing apparatus in response to said input data signals.

29. The system of claim 28, wherein said data processing apparatus comprises a system-on-a-chip.

30. The system of claim 29, wherein said software model is operable using said captured representation of said input data signals to generate simulated internal data signals representing signals generated within said component of said data processing apparatus in response to said input data signals.

31. The system of claim 29, wherein said software model is operable using said captured representation of said input data signals to generate simulated output data signals representing output signals of said component of said data processing apparatus in response to said input data signals.

32. The system of claim 31, wherein said input signals represent compressed data values and said simulated output data signals represent uncompressed data values.

33. The system of claim 29, wherein said data processing apparatus comprises at least one additional component operable to receive output data signals from said component, said software model is operable to simulate the behaviour of said component and said additional component of said data processing apparatus using said captured representation of said input data signals to generate simulated output data signals representing output signals of said component of said data processing apparatus in response to said input data signals and using said simulated output data signals to generate additional data signals representing the behaviour of said additional component of said data processing apparatus in response to said input data signals.

34. The system of claim 33, wherein said software model is operable using said captured representation of said input data signals to generate said simulated output data signals representing said output signals of said component of said data processing apparatus in response to said input data signals and using said simulated output data signals to generate additional internal data signals representing signals generated within said additional component of said data processing apparatus in response to said input data signals.

35. The system of claim 33, wherein said software model is operable using said captured representation of said input data signals to generate said simulated output data signals representing said output signals of said component of said data processing apparatus in response to said input data signals and using said simulated output data signals to generate additional output data signals representing signals output by said additional component of said data processing apparatus in response to said input data signals.

36. The system of claim 29, wherein said logic is further operable to capture a representation of data signals generated by said component of said data processing apparatus in response to said input data signals.

37. The system of claim 36, wherein said logic is further operable to capture a representation of internal data signals generated within said component of said data processing apparatus in response to said input data signals.

38. The system of claim 36, wherein said logic is further operable to capture a representation of output data signals output by said component of said data processing apparatus in response to said input data signals.

39. The system of claim 36, wherein said logic is further operable to provide said captured representation of data signals generated by said component of said data processing apparatus to said software model.

40. The system of claim 29, wherein said data processing apparatus comprises at least one additional component and said logic is further operable to capture a representation of data signals generated by said additional component of said data processing apparatus.

41. The system of claim 40, wherein said logic is further operable to capture a representation of internal data signals generated within said additional component of said data processing apparatus.

42. The system of claim 40, wherein said logic is further operable to capture a representation of output data signals output by said additional component of said data processing apparatus.

43. The system of claim 40, wherein said logic is further operable to provide said captured representation of data signals generated by said additional component of said data processing apparatus to said software model.

44. The system of claim 43, wherein said software model is further operable to to compare said simulated data signals generated with said captured representation of data signals generated by said additional component of said data processing apparatus.

45. The system of claim 29, wherein said logic is further operable to capture a representation of said input data signals in a stored data file.

46. The system of claim 45, further comprising a file reader operable to receive said representation of said input data signals stored in said data file and to generate transactions to stimulate said software model to generate said simulated data signals representing the behaviour of said component of said data processing apparatus in response to said input data signals.

47. The system of claim 29, wherein said logic is operable to capture a representation of said input data signals by sampling from a bus.

48. The system of claim 29, wherein said logic comprises a trace module operable to capture a representation of said input data signals by tracing said input data signals.

49. The system of claim 29, wherein said software model is operable to be single-stepped using said captured representation of said input data signals to generate simulated data signals representing the behaviour of said component of said data processing apparatus in response to said input data signals.

50. The system of claim 29, further comprising a model analysis tool operable to analyse said simulated data signals.

51. The system of claim 50, wherein said model analysis tool is operable to determine waveform representations of said simulated data signals.

52. The system of claim 50, wherein said model analysis tool is operable to determine one of register and memory contents derivable from said simulated data signals.

53. The system of claim 50, wherein said model analysis tool is operable to determine statistical information derivable from said simulated data signals.

54. The system of claim 28, wherein said logic is operable to capture said representation of input data signals provided to said component of said data processing apparatus in response to a sequence of instructions being executed by said data processing apparatus.

55. A software model operable when executed on a computer to simulate the behaviour of a component of a data processing apparatus, said software model comprising:
a model interface operable to receive a captured representation of input data signals received by said component of said data processing apparatus; and
a simulation model operable to generate, from said captured representation of input data, simulated data signals representing the behaviour of said component of said data processing apparatus in response to said input data signals.
